(19) United States
(12) Patent Application Publication
(10) Pub. No.: US 2026/0071372 A1
(43) Pub. Date: Mar. 12, 2026

(54) LAUNDRY MACHINE

(71) Applicant: LG Electronics Inc., Seoul (KR)

(72) Inventors: Sunghwan BAE, Seoul (KR); Jihun KIM, Seoul (KR); Mingyu KIM, Seoul (KR)

(21) Appl. No.: 19/303,737

(22) Filed: Aug. 19, 2025

(30) Foreign Application Priority Data
Sep. 9, 2024 (KR) 10-2024-0122478

(51) Int. Cl. D06F 39/02; B01F 23/50; B01F 23/53; B01F 27/113; B01F 27/91; B01F 35/32; B01F 35/71; B01F 101/00; D06F 23/04

(52) U.S. Cl. CPC D06F 39/028; B01F 23/53; B01F 23/56; B01F 27/113; B01F 27/91; B01F 35/32015; B01F 35/712; B01F 35/7179; D06F 23/04; B01F 2101/4505

(57) ABSTRACT

A laundry machine according to an embodiment of the present invention, comprises: a cabinet; a tub rotatably disposed in the cabinet; and a detergent supply device provided in the cabinet that mixes washing water and powdered detergent and discharges the mixture into the tub, wherein the detergent supply device comprises: a housing disposed at the cabinet; a drawer that is withdrawably provided in the housing and has a receiving portion for receiving the powdered detergent; and a mixing member disposed in the receiving portion that mixes the powdered detergent by rotation, and wherein the mixing member includes a plurality of blades radially arranged around a rotating shaft, and the blade is formed with a blade groove penetrating the blade to allow the powdered detergent to pass through the blade.

### CROSS-REFERENCE TO RELATED APPLICATIONS

The present application claims the benefits of priority to Korean Patent Application No. 10-2024-0122478, filed on Sep. 9, 2024, of which its incorporated herein by reference in its entirety.

### THE BACKGROUND

### 1. The Field

The present invention is related to a laundry machine.

### 2. Description of the Related Art

Generally, a laundry machine is a home appliance that performs washing operations by appropriately mixing detergent and washing water after the user puts laundry into the washing tub and enters the operation command.

Recent laundry machines are equipped with a detergent supply device that can use both solid and liquid detergents, and the detergent and washing water are supplied together into the washing tub according to the supply of washing water.

The detergent supply device can be configured to receive detergent in powder or liquid form and to further add an auxiliary agent, such as a fabric softener. The detergent supply device has a structure that can be drawn out or inserted. The detergent supply device allows detergent to be added when drawn out, and when inserted, the detergent is dissolved in the supplied water and supplied to the washing tub. Furthermore, the detergent supply device may be equipped with a rotating fan to dissolve the powdered detergent.

However, if powdered detergent is excessively supplied to the drawer where the fan is installed, or if powdered detergent is excessively applied to a portion of the entire fan area, the fan may not rotate properly.

Furthermore, if the fan does not rotate properly, the powdered detergent may not sufficiently dissolve in the wash water, and the remaining powdered detergent may significantly deteriorate the wash quality.

This problem can be more severe if the water pressure supplied to the laundry machine is weak.

### THE SUMMARY

A laundry machine according to an embodiment of the present invention may comprise: a cabinet; a tub rotatably disposed in the cabinet; and a detergent supply device provided in the cabinet that mixes washing water and powdered detergent and discharges the mixture into the tub, wherein the detergent supply device comprises: a housing disposed at the cabinet; a drawer that is withdrawably provided in the housing and has a receiving portion for receiving the powdered detergent; and a mixing member disposed in the receiving portion that mixes the powdered detergent by rotation, and wherein the mixing member includes a plurality of blades radially arranged around a rotating shaft, and the blade is formed with a blade groove penetrating the blade to allow the powdered detergent to pass through the blade.

The blade groove may be formed to extend upward from the bottom of the blade.

The blade groove may become narrower as the blade groove extends upward.

The blade groove may extend downwards further than a midpoint of the upper and lower heights of the blade.

The blade grooves may be formed on each of the plurality of blades, and the blade grooves formed on adjacent blades may be formed at positions where they do not overlap each other during the rotation process.

The blade grooves may be formed on each of the plurality of blades, and the blade grooves formed on adjacent blades may be formed in different numbers.

The sum of the areas of the blade grooves formed on each of the above blades may be the same.

The blade groove may comprise: a first blade groove formed singly on a plurality of blades; and a second blade groove formed in multiple numbers on a blade adjacent to the blade on which the first blade groove is formed.

The first blade groove may be formed between the second blade grooves based on the rotation radius of the blade.

The first blade groove may be formed in the center based on both ends of the blade.

The second blade grooves may be provided on both sides based on the center of the blade.

The first blade groove and the second blade groove may be formed to have the same size.

The housing may be formed with a nozzle that sprays water toward the blade to rotate the mixing member, and an opening of the nozzle may be formed to face upwards of the blade groove.

The blade may be formed so that an upper end of the blade is inclined more toward the direction of rotation of the mixing member than a lower end of the blade, and the extension line passing through the nozzle intersects the blade.

An upper surface of the housing may be provided with a flow path member that forms a flow path for guiding the washing water, and

The flow path member may be provided with a discharge path that is gradually inclined downward toward the blade, and the nozzle may be formed at the end of the discharge path.

A lower surface of the housing may be provided with a rack extending in the direction of withdrawal of the drawer, and the mixing member may be provided with a pinion connected to rotate with the drawer, and the pinion may be gear-coupled with the rack and rotates when the drawer is drawn in and out.

The rotating shaft may extend downward through the bottom of the receiving portion, and the pinion may be coupled to the lower end of the rotating shaft at the lower end of the housing.

A housing recess may be formed on the lower front end of the housing to prevent interference of the pinion when the drawer is drawn in and out.

The blade groove may be opened toward the bottom of the receiving portion, and a lower end of the blade groove may be spaced apart from the bottom of the receiving portion.

An auxiliary blade extending in the opposite direction to the rotational direction of the mixing member may be formed at one end of the blade farthest from the rotating shaft.

The following effects can be expected from the laundry machine according to the proposed embodiment.

In a laundry machine according to an embodiment of the present invention, when powdered detergent is supplied to the detergent supply device, even if the powdered detergent is concentrated and supplied to a portion of the mixing member, the powdered detergent can be moved through the blade grooves of the mixing member by rotation of the mixing member.

The powdered detergent supplied within the drawer can be distributed through the grooves of the mixing member, and can be more evenly distributed by the rotation of the mixing member. Accordingly, the powdered detergent can be evenly distributed within the drawer, ensuring the dissolution of the powdered detergent when the washing water is supplied.

Additionally, the mixing member can rotate in conjunction with the drawer's insertion. Furthermore, as the drawer is drawn in, the powdered detergent is evenly distributed, ensuring the normal operation of the mixing member when the nozzle distributes the wash water.

Therefore, when adding the powdered detergent to the drawer, the user can add the powdered detergent regardless of the adding location, thereby enhancing user convenience. Furthermore, when adding powdered detergent, the mixing member operates smoothly, ensuring that the powdered detergent is supplied to the tub in a sufficiently dissolved state, thereby improving wash quality.

Furthermore, the mixing member can rotate the mixing member with less force, allowing the powdered detergent to escape through the blade grooves even when a large amount of powdered detergent is placed between the blades. Accordingly, even when the water pressure of the washing water supplied from the water supply device is weak, it is possible to prevent a decline in washing quality due to residual detergent.

### BRIEF DESCRIPTION OF THE DRAWINGS

FIG. 1 is a perspective view of a laundry machine according to an embodiment of the present invention.

FIG. 2 is a rear view of the laundry machine.

FIG. 3 is a perspective view showing the detergent supply device mounted on the upper frame of the washing machine.

FIG. 4 is a perspective view of the detergent supply device.

FIG. 5 is a perspective view of the detergent supply device with the drawer withdrawn.

FIG. 6 is a perspective view showing the housing and drawer of the detergent supply device separated.

FIG. 7 is an exploded perspective view of the detergent supply device.

FIG. 8 is a cross-sectional view of FIG. 4 along line 8-8.

FIG. 9 is a perspective view of the housing, viewed from the bottom.

FIG. 10 is a drawing showing the connection between the rack of the housing and the pinion of the mixing member.

FIG. 11 is a perspective view of the mixing member.

FIG. 12 is an enlarged view of the blade of the mixing member.

FIG. 13 is a front view of the mixing member.

FIG. 14 is a plan view of the mixing member.

FIG. 15 is a cutaway perspective view showing the operating state of the mixing member.

FIG. 16 is a plan view showing the operating state of the mixing member.

### DETAILED DESCRIPTION

The following describes in detail specific embodiments of the present invention with reference to the accompanying drawings. However, the present invention is not limited to the embodiments in which the ideas of the present invention are presented, and other embodiments that fall within the scope of the ideas of the present invention can be easily proposed by adding, changing, or deleting other components.

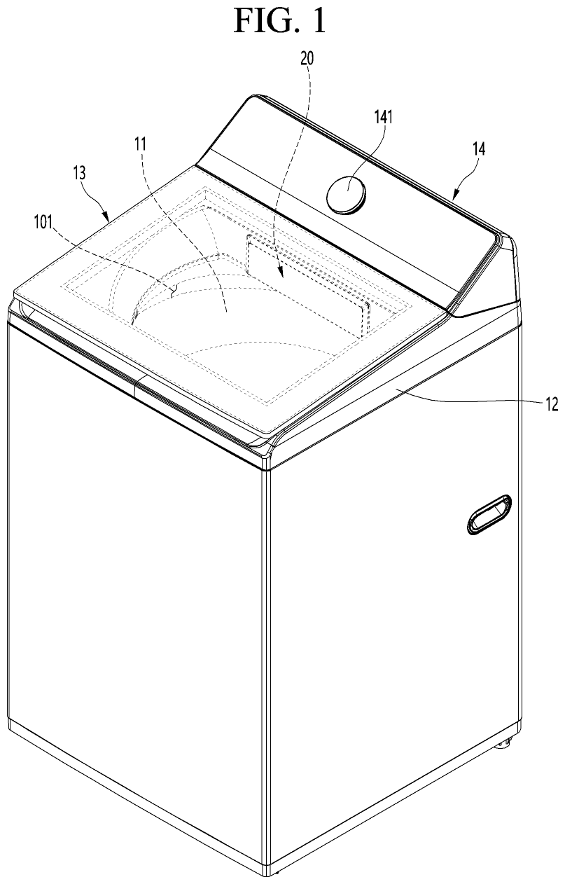

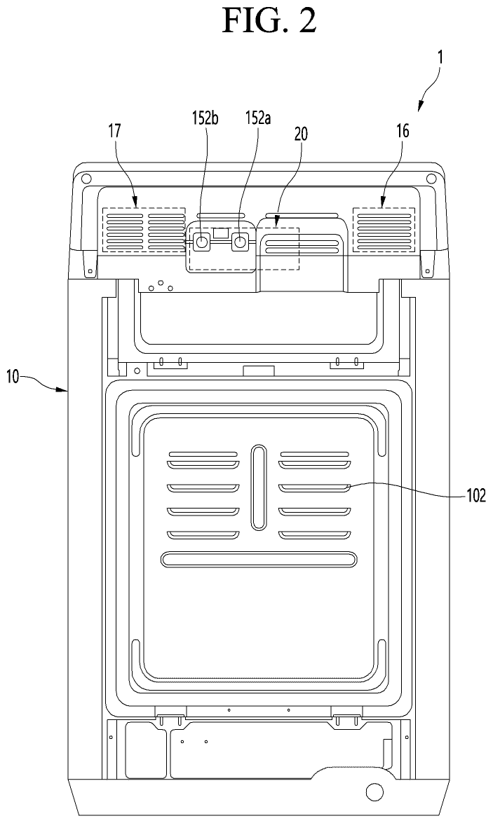

Before proceeding with the description, the directions are defined. In the embodiment of the present invention, with respect to a center point of the laundry machine shown in FIGS. 1 and 2, the direction toward the floor surface where the laundry machine is installed is defined as a downward direction, the direction toward the surface where the opening for the input port is formed in the cabinet is defined as an upward direction, the direction toward the surface where the back plate is installed is defined as a rearward direction, and the direction toward the surface opposite the rearward direction is defined as a forward direction. When referring to directions not explicitly defined, the directions can be defined and described based on each figure.

Furthermore, while the embodiment of the present invention is illustrated using an example of a top-loading type laundry machine with a door formed on the upper surface and laundry being loaded through the opened upper surface, the present invention is not limited to the structure and form of the laundry machine and is applicable to all forms of laundry machines equipped with a detergent supply device. For example, the present invention is applicable to various laundry machines, including drum laundry machines.

FIG. 1 is a perspective view of the laundry machine according to an embodiment of the present invention, and FIG. 2 is a rear view of the laundry machine.

Referring to FIGS. 1 and 2, the laundry machine 1 according to an embodiment of the present invention includes a cabinet 10, an upper frame 12 placed on the upper surface of the cabinet 10, a door 13 that is rotatably connected to the upper frame 12, and a control panel 14 mounted on the rear edge of the upper frame 12.

In detail, the cabinet 10 forms the exterior of the laundry machine 1 and can form a space for washing inside thereof.

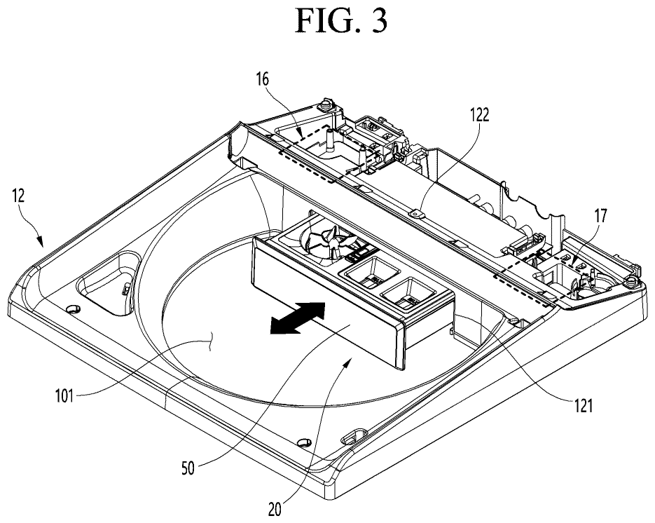

For example, the cabinet 10 may be formed in a hexahedral shape, with an open upper surface, and the upper frame 12 covers the open upper surface of the cabinet 10. Furthermore, the upper frame 12 includes an inlet 101 (See FIG. 3), and the door 13 opens and closes the inlet 101.

Furthermore, the interior of the cabinet 10 accommodates a tub 11 connected to the inlet 101. The upper surface of the tub 11 is open and communicates with the inlet 101, and the interior of the tub 11 may accommodate a washing drum for receiving laundry. The washing drum may include a cylindrical drum. Furthermore, the interior of the cabinet 10 may be equipped with a motor and other drive devices for driving the drum.

For example, the control panel 14 may be provided on the upper surface of the upper frame 12 corresponding to the rear side of the inlet 101. Furthermore, the control panel 14 may be equipped with operating members 141 for operating the laundry machine 1. For example, the operating members 141 may include a knob and buttons. Additionally, the control panel 14 may be further equipped with a display for indicating the operation of the laundry machine 1.

The rear end of the door 13 is pivotably connected to the upper frame 12, allowing the user to lift or lower the front end of the door 13 to open or close the inlet 101. Additionally, at least a portion of the door 13 may be formed to be see-through such as transparent or translucent. Therefore, the user can see the inside of the washing drum through the see-through part of the door 13.

Meanwhile, the rear of the cabinet 10 may be formed by a back cover 102. When the back cover 102 is separated or removed, the components installed inside the laundry machine 1 become accessible for maintenance. For example, when the back cover 102 is separated, the power supply device 16, the water level sensor 17, and water supply device 15 arranged on the control panel 14 can be replaced or repaired.

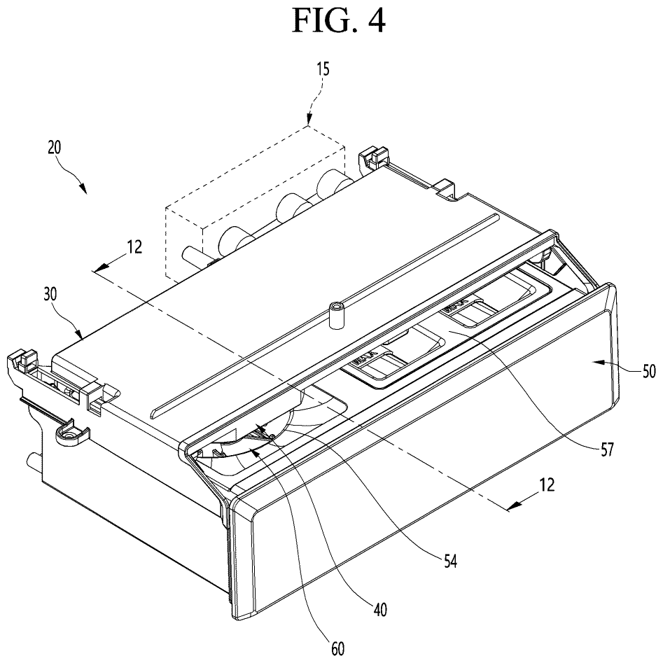

Additionally, the rear of the cabinet 10 may be equipped with a water supply pipe connection portion 152. The water supply pipe connection portion 152 may be connected to a water supply hose extending from an external water source. The water supply pipe connection portion 152 may be part of the water supply device 15 (See FIG. 4) described below. The water supply device 15 includes a plurality of valves and may be connected to a detergent supply device 20 arranged inside the cabinet 10. The water supply pipe connection portion 152 may include a hot water pipe connection portion 152a for supplying hot water and a cold water pipe connection portion 152b for supplying cold water. The water supply device 15 is described in more detail below with reference to the drawings.

The detergent supply device 20 may be provided on one side of the inlet 101, specifically on the rear side of the inlet 101. The detergent supply device 20 is configured to be withdrawable forward from the rear edge of the inlet 101, allowing the user to supply detergent into the detergent supply device 20. Furthermore, the detergent supply device 20 is connected to the water supply device 15, so that the detergent introduced into the detergent supply device 20 can be mixed with water supplied from the water supply device 15 and then supplied into the interior of the tub 11.

The following describes the detergent supply device 20 in more detail with reference to the drawings.

FIG. 3 is a perspective view of the upper frame showing the detergent supply device in the withdrawn state, FIG. 4 is a perspective view of the detergent supply device.

Referring to FIGS. 3 to 5, the upper frame 12 forming the inlet 101 is coupled to the upper surface of the cabinet 10

In detail, the upper frame 12 forms the upper part of the laundry machine 1, and the inlet 101 can be closed by the door 13. Additionally, the control panel 14 can be arranged on the rear side of the upper surface of the upper frame 12.

Furthermore, the detergent supply device 20 may be disposed on the upper frame 12. The detergent supply device 20 may be inserted into the frame opening 121 formed on one side of the inlet 101, specifically on the rear side of the inlet 101. Furthermore, the detergent supply device 20 is mounted inside the upper frame 12 through the frame opening 121. The detergent supply device 20 includes a housing 30 fixed inside the upper frame 12, a drawer 50 that can be pulled out and inserted into the housing 30, and a flow path member 40 that is connected to the housing 30 to form a flow path of water that is supplied to the drawer 50. Furthermore, in a state where the drawer 50 is closed, i.e., inserted into the interior of the housing 30, the front surface of the drawer 50 may form a portion of the rear surface of the inlet 101.

The detergent supply device 20 may be positioned at the lower central portion of the control panel 14. Furthermore, on the left and right edges of the control panel 14 corresponding to the left and right edges of the detergent supply device 20, a power supply device 16 for supplying power to drive the laundry machine 1 and a water level sensor 17 for detecting the water level in the tub 11 may be provided, respectively. Furthermore, a PCB may be arranged in the central portion of the control panel 14 corresponding to the upper side of the detergent supply device 20, which is electrically connected to various components including the operation unit arranged on the front of the control panel 14.

In addition, the water supply device 15 may be connected to the rear end of the detergent supply device 20. Furthermore, in a state where the detergent supply device 20 is installed, the water supply device 15 may be exposed externally from the rear of the laundry machine 1 and connected to a water supply pipe.

The water supply device 15 may be connected to the housing 30 of the detergent supply device 20. The water supply device 15 may include a plurality of valves for supplying water to the detergent supply device. In addition, the water supply device 15 includes a hot water pipe connection part 152a through which hot water is supplied and a cold water pipe connection part 152b through which cold water is supplied, and the hot water pipe connection part 152a and the cold water pipe connection part 152b may be exposed to the rear of the cabinet 10.

The water supply device 15 is connected to the rear of the housing 30, and the flow path member 40 is mounted on the upper surface inside the housing 30 to form a flow path that communicates with the water supply device 15. Furthermore, the flow path member 40 is positioned above the drawer 50 in the state where the drawer 50 is closed. Therefore, water can fall from above the drawer 50 through the flow path member 40, and the falling water can be mixed with the detergent introduced into the drawer 50 and supplied to the tub 11.

For example, the drawer 50 may have a receiving portion 53. Specifically, the receiving portion 53 may include a first receiving portion 54, a second receiving portion 55, and a third receiving portion 56. Furthermore, the flow path member 40 may have independent flows directed toward each of the first receiving portion 54, second receiving portion 55, and third receiving portion 56. That is, by simply mounting a single flow path member 40 on the housing 30, it is possible to provide multiple flow paths that supply water to each of the multiple receiving portions 54, 55, 56 formed in the drawer 50.

Hereinafter, the detergent supply device 20 will be described in more detail with reference to the drawings.

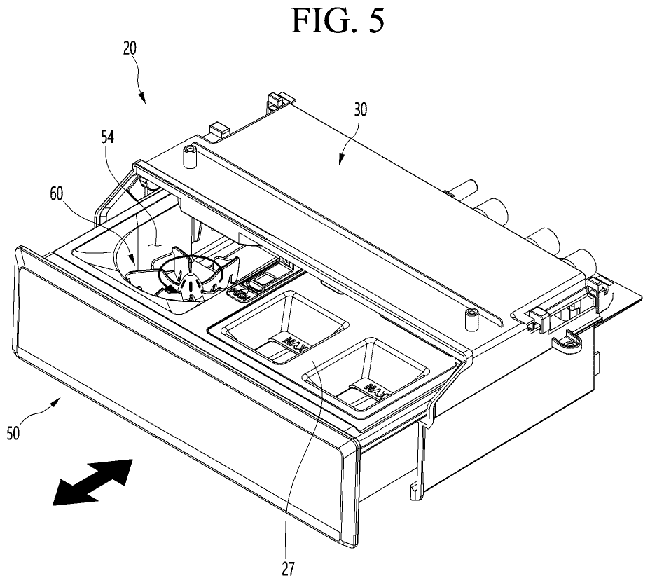

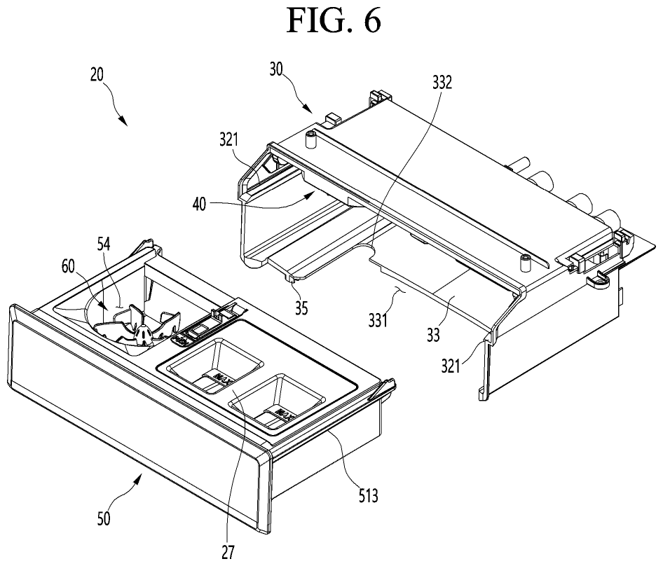

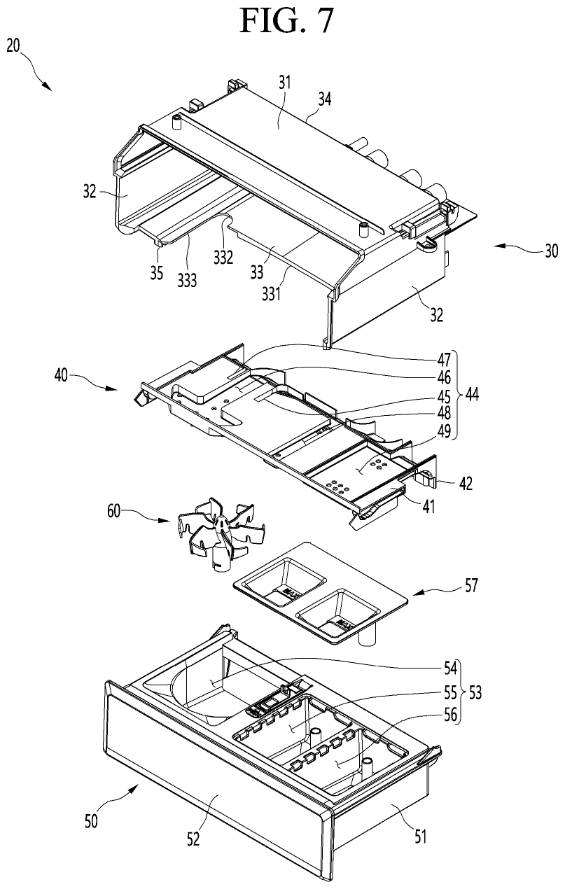

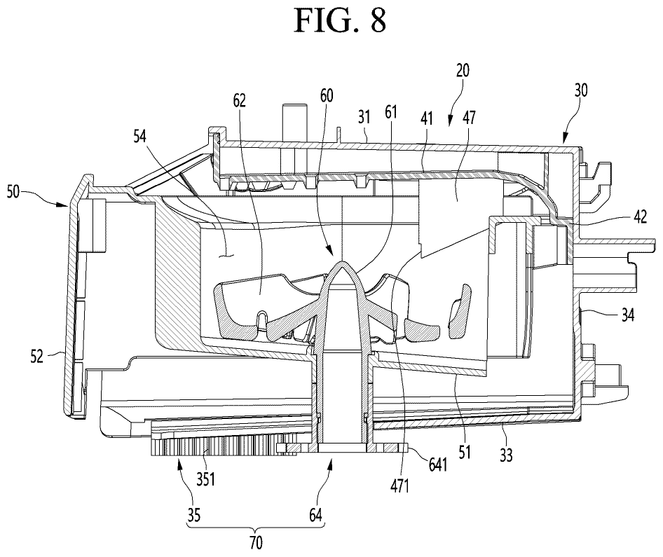

FIG. 5 is a perspective view of the detergent supply device with the drawer withdrawn, FIG. 6 is a perspective view showing the housing and drawer of the detergent supply device separated, FIG. 7 is an exploded perspective view of the detergent supply device, and FIG. 8 is a cross-sectional view of FIG. 4 along line 8-8.

As shown, the housing 30 can be formed into a box-shaped structure with an open front, and can form a receiving space 300 that accommodates the flow path member 40 and the drawer 50 inside.

The housing 30 may be connected to a water supply device 15 at the rear, and water supplied through the water supply device 15 may be supplied to the drawer 50 via the flow path member 40. For this purpose, the flow path member 40 can be coupled to the interior of the housing 30.

The housing 30 is mounted to the upper frame 12. In addition, the open front surface of the housing 30 can be exposed through the frame opening 121. Housing guides 321 that guide the drawing out and inlet of the drawer 50 are formed stepwise on both sides of the housing 30, and a drawer guide 513 formed on the drawer 50 is coupled on the housing guide 321.

A rack 35 for rotation of the mixing member 60 when the drawer 50 is drawn in and out may be provided on the lower surface 33 of the housing 30. In addition, a housing recessed portion 331 that is recessed backward may be formed on the front end of the lower surface 33 of the housing 30. In addition, a pinion receiving portion 332 may be formed in the housing recessed portion 331. Detergent mixed with washing water in the drawer 50 may fall downward from the housing recessed portion 331 and be supplied to the inside of the tub 11.

Meanwhile, the flow path member 40 can be mounted on the upper surface of the interior of the housing 30. Furthermore, the flow path member 40 can have a plurality of flow passages formed with open upper surfaces. Therefore, when the flow path member 40 is mounted on the housing 30, one or more flow passages may be formed to supply water to the drawer 50 via the housing 30 and the flow path member 40. Furthermore, in a state where the flow path member 40 is mounted, the one or more flow passages may communicate with the water supply device 15.

The flow path member 40 may be positioned on the upper side of the drawer 50 when mounted on the housing 30. Furthermore, the front end of the flow path member 40 may extend to the front end of the upper surface of the housing 30. Therefore, water may fall toward the drawer 50 across the entire upper surface area of the receiving space 300.

The flow path member 40 may be formed to a size corresponding to the upper surface of the housing 30. The rear end of the flow path member 40 may extend downward and contact the rear surface of the housing 30. The rear surface of the flow path member 40 may be connected to the water supply device 15.

The flow path member 40 may be formed with a distribution path 43 and a discharge path 44 for supplying water to the receiving portion 53. The discharge path 44 may be recessed to a predetermined depth and, when coupled with the housing 30, may form an independent flow path.

In detail, the flow path member 40 may include an upper part 41 and a rear part 42. A portion of the upper part 41 contacts the upper surface of the housing 30, while another portion is recessed to form a flow path through which water supplied to the drawer 50 flows. That is, the open upper surfaces of the flow paths formed in the flow path member 40 can be shielded by the upper surface of the housing 30.

The rear part 42 can extend downward from the rear end of the upper part 41. The rear part 42 can contact the rear surface of the housing 30. A predetermined space can be formed between the rear surface of the flow path member 40 and the rear edge of the housing 30, defining at least a portion of the distribution path 43.

Therefore, water supplied from the water supply device 15 to the housing 30 can pass through the washing water supply space and be supplied to multiple flow paths formed in the upper part 41.

The distribution path 43 is formed with a plurality of ribs to distribute the water supplied to the discharge paths 44.

Meanwhile, the flow path may include a distribution path 43 and a discharge path 44. For example, the discharge path 44 may include a first discharge path 45 that supplies water to the first receiving portion 54, a second discharge path 46 that supplies water to the mixing member 60, and a third discharge path 47. Furthermore, the discharge path 44 may further include a fourth discharge 48 that supplies water to the second receiving portion 55. Furthermore, the discharge path 44 may further include a fifth discharge path 49 that supplies water to the third receiving portion 56.

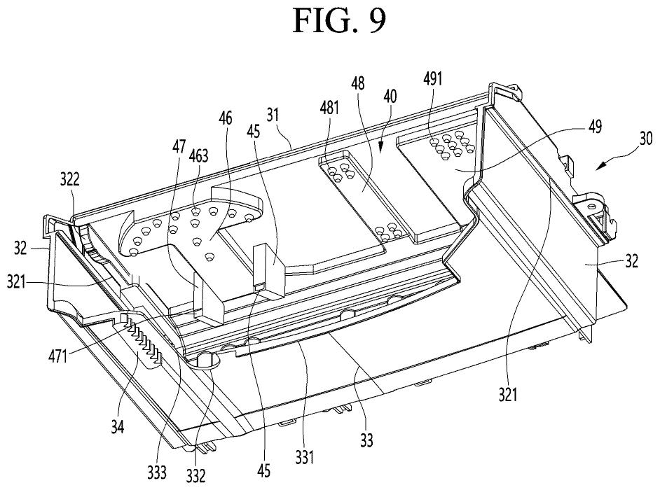

In detail, the first discharge path 45 extends forward from the front end of the distribution path 43 toward the blade 62 of the mixing member 60. That is, the first discharge path 45 may extend toward a point radially to the right from the rotational center axis of the mixing member 60. Furthermore, a nozzle (451 in FIG. 9) may be formed at the front lower portion of the first discharge path 45. The nozzle 451 may open toward the surface of the blade 62, and the opening shape of the nozzle 451 may be designed in various shapes.

The second discharge path 46 extends forward from the distribution path 43 and may extend past the center of the first receiving portion 54. A plurality of shower holes 463 may be formed in the second discharge path 46. The shower holes 463 are evenly arranged within the first receiving portion 54, minimizing the residual detergent within the first receiving portion 54. The shower holes 463 may be defined as the first shower holes, distinguishable from the second shower holes (481 in FIG. 9) of the fourth discharge path 48 and the third shower holes (491 in FIG. 9) of the fifth discharge path 49.

The third discharge path 47 is intended to wash away the detergent powder on the surface of the blade 62 and may be positioned laterally relative to the second discharge path 46. Furthermore, the first discharge path 45 and the third discharge path 47 may be positioned parallel to each other on opposite sides relative to the second discharge path 46. The surface (rear) of the blade 62 against which the washing water discharged from the third discharge path 47 collides can be understood as the opposite surface of the surface (front) of the blade 62 against which the washing water sprayed from the nozzle 451 of the first discharge channel 45 collides.

A second nozzle 471 may be formed at the lower front portion of the third discharge path 47 to spray water in a direction opposite to the rotational direction of the mixing member 60. The second nozzle 471 may be formed at the lower portion of the third discharge path 47. The water sprayed from the second nozzle 471 is directed toward the rear of the blade 62.

Meanwhile, the fourth discharge path 48 may be located above the second receiving portion 55. In addition, a plurality of second shower holes 481 are formed in the fourth discharge path 48, through which washing water can be supplied to the second receiving portion 55.

The fifth discharge path 49 may be positioned above the third receiving portion 56. In addition, a plurality of third shower holes 491 are formed in the fifth discharge path 49, through which washing water can be supplied to the third receiving portion 56.

Meanwhile, the drawer 50 may be accommodated within the receiving space 300. The drawer 50 may be arranged so that it can be pulled out and pushed in through the open front of the housing 30. The drawer 50 may form a plurality of downwardly recessed receiving portions 53. The plurality of receiving portions 53 may be filled with detergent for washing.

For example, the drawer 50 may include a drawer body 51 in which the receiving portion 53 is formed, and a drawer front 52 provided in front of the drawer body 51 and forming the front of the drawer 50. The drawer front 52 and the drawer body 51 are spaced apart from each other, so that the drawer front 52 can be used as a handle when a user draws in and out the drawer 50.

For example, the receiving portions 53 may include a first receiving portion 54 for powder detergent, a second receiving portion 55 for liquid detergent, and a third receiving portion 56 for fabric softener. Of course, the second receiving portion 55 or the third receiving portion 56 may be omitted as needed.

The passages formed in the flow path member 40 may be formed on the upper side corresponding to the first receiving portion 54, the second receiving portion 55, and the third receiving portion 56. Furthermore, the water supplied from the water supply device 15 may be divided and supplied independently to the first receiving portion 54, the second receiving portion 55, and the third receiving portion 56.

Meanwhile, a mixing member 60 may be provided inside the first receiving portion 54. The mixing member 60 may be formed in the shape of a fan or propeller having multiple blades. Furthermore, the mixing member 60 may be rotatably arranged in the first receiving portion 54. The mixing member 60 may be rotated by water sprayed from the nozzle 451 formed in the flow path member 40. The mixing member 60 may be defined as a rotating member or mixing fan.

When washing water is supplied through the nozzle 451 in a state where powdered detergent is introduced into the first receiving portion 54, the mixing member 60 rotates to mix the washing water and the powdered detergent. The powdered detergent dissolved in the washing water can then be supplied to the tub 11 from the first receiving portion 54. For this purpose, at least a portion of the rear of the first receiving portion 54 can be opened.

In addition, a pinion 64 may be provided at the bottom of the mixing member 60. The pinion 64 may be coupled with the rack 35, and may move along the rack 35 when the drawer 50 is drawn in and out to rotate the mixing member 60. That is, the mixing member 60 may be rotated when the drawer 50 is drawn in and out, and the rotational motion of the mixing member 60 for mixing powdered detergent may be visualized.

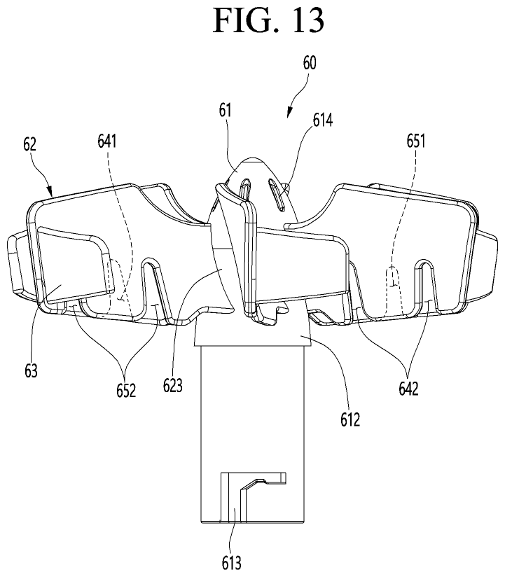

The second receiving portion 55 and third receiving portion 56 may be provided with a receiving portion cover 57. The receiving portion covers 57 may be placed on the open upper surfaces of the second receiving portion 55 and third receiving portion 56, and may be formed to slope downward along the concave shapes of the second receiving portion 55 and third receiving portion 56. Furthermore, cover holes 571, 572, 575, 576 (See FIG. 13) through which water falling from the flow path member 40 is supplied may be formed in the bottom portion of the recessed part of the receiving cover 57 formed with a downward slope and in the rear end of the receiving cover 57.

In this embodiment, the receiving portion cover 57 is presented in a manner that the recessed portions corresponding to the second receiving portion 55 and the third receiving portion 56 are formed as a single unit, but, it may also be provided as separate cover structures that shield the second receiving portion 55 and the third receiving portion 56 respectively.

The following describes the structure of the housing in more detail with reference to the drawings.

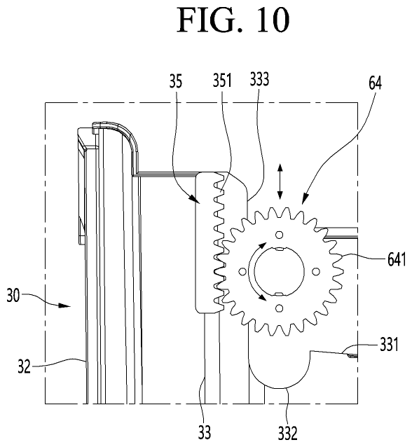

FIG. 9 is a perspective view of the housing, viewed from the bottom, and FIG. 10 is a drawing showing the connection between the rack of the housing and the pinion of the mixing member.

As illustrated, the housing 30 has an open front and includes an upper surface 31, left and right sides 32, a lower surface 33, and a rear surface 34, and may be formed in a box shape. Furthermore, the drawer 50 can be drawn in and out through the open front of the housing 30.

The flow path member 40 may be mounted on the upper surface of the housing 30. The flow path member 40 is positioned above the drawer 50 and faces the upper surface of the receiving portion 43, thereby forming a flow path through which washing water falls into the receiving portion 43.

The first discharge path 45 and the third discharge path 47 formed on the flow path member 40 may protrude forward and downward at an angle. And, a first nozzle 451 may be formed in the first discharge path 45. The first nozzle 451 is opened toward one side of the blade 62, and the blade 62 can be rotated by the pressure of water sprayed from the first nozzle 451 toward the front of the blade 62. And, a second nozzle 471 may be formed in the third discharge path 47. The second nozzle 471 is opened toward the other side of the blade 62, and water can be sprayed toward the back of the blade 62 to wash away detergent remaining on the blade 62.

Furthermore, the second discharge path 46 may be formed with multiple shower holes 563 to spray water from above to below into the interior of the first receiving portion 54. Furthermore, the fourth discharge path 48 may be formed with second shower holes 481 to spray water into the interior of the second receiving portion 55. Furthermore, the fifth discharge path 49 may be formed with third shower holes 491 to spray water into the interior of the third receiving portion 56.

The housing guides 321 may extend forward and backward on both left and right sides of the housing 30. Furthermore, a restriction member 322 may be further formed on both sides of the upper surface of the housing 30 to restrict the withdrawal and insertion of the drawer 50. The restriction 322 protrudes downward and can restrain the drawer 50 in the maximum withdrawal state of the drawer 50.

A portion of a driving part for driving the mixing member may be formed on the lower surface of the housing 30. That is, the driving part 70 may be provided on both the housing 30 and the mixing member 60. For example, the driving part 70 may include a rack 35 formed on the lower surface of the housing 30 and a pinion 64 provided at the lower end of the mixing member 60.

Furthermore, a housing recessed portion 331 may be formed on the front end of the lower surface of the housing 30. This housing recessed portion 331 may be recessed rearward to avoid interference with the mixing member 60 or pinion 64 protruding downward from the drawer 50 when the drawer 50 is drawn in and out.

The housing recessed portion 331 may extend rearwardly, except for the left and right ends. The housing recessed portion 331 may be recessed to a position rearward of the rotational shaft 61 when the drawer 50 is fully inserted.

A pinion guide 333 may be formed on one of the left and right sides of the housing recessed portion 331 where the rack 35 is formed. The pinion guide 333 may extend forward and backward parallel to the side surface 32 of the housing 30. When the drawer 50 is drawn in and out, the pinion 64 may move along the pinion guide 333. Furthermore, the rack 35 may extend forward and backward along the pinion guide 333.

The rack 35 may be formed on the lower surface 33 of the housing 30. The rack 35 may protrude downward from the lower surface 33 of the housing 30. Therefore, the rack 35 may not face the inside of the housing 30 and thus may not come into direct contact with detergent or washing water.

The rack 35 may have a rack gear 351 continuously formed on one surface to enable gear coupling with the pinion 64. The rack 35 may be formed integrally with the housing 30. Alternatively, the rack 35 may be separately formed and then joined to the lower surface of the housing 30.

The rack 35 may extend rearward from the front end of the lower surface of the housing 30. The rack 35 may be formed along the lateral side of the housing recessed portion 331. Furthermore, the rack 35 may be spaced laterally from the lateral side of the housing recessed portion 331. The rack 35 may have a length shorter than the stroke of the drawer 50. That is, when the drawer 50 is fully inserted, the rack 35 and the pinion 64 may not be coupled to each other. Furthermore, the rack 35 and the pinion 64 may be coupled to each other while the drawer 50 is being drawn in and out.

A pinion receiving portion 332 may be formed on the lower surface of the housing 30. The pinion receiving portion 332 may be formed in the housing recessed portion 331. The rack 35 and pinion receiving portion 332 can be formed along the housing recessed portion 331.

Specifically, the pinion receiving portion 332 may be formed at the rear of the rack 35. The pinion receiving portion 332 may be formed at the rear end of the pinion guide portion 333 and may accommodate the rotating shaft 61 of the mixing member 60 or the boss portion 643 of the pinion 64. Therefore, when the drawer 50 is fully inserted, the pinion 64 may be positioned in the pinion receiving portion 332, and since it is separated from the rack 35, the mixing member 60 may be freely rotatable.

In this state, when water is sprayed from the first nozzle 451 toward the blade 62, the mixing member 60 may rotate, allowing the powdered detergent to more easily dissolve in the washing water.

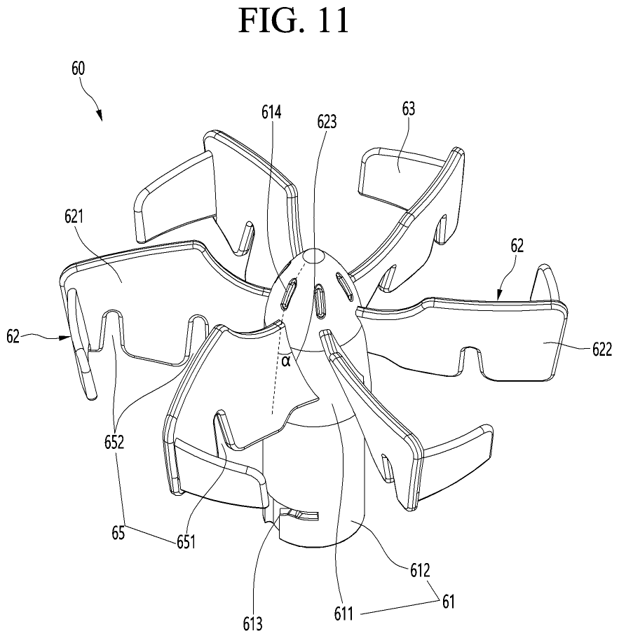

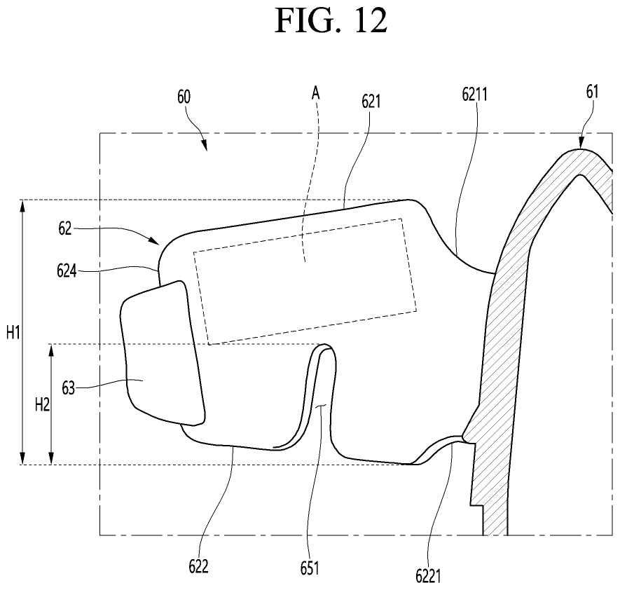

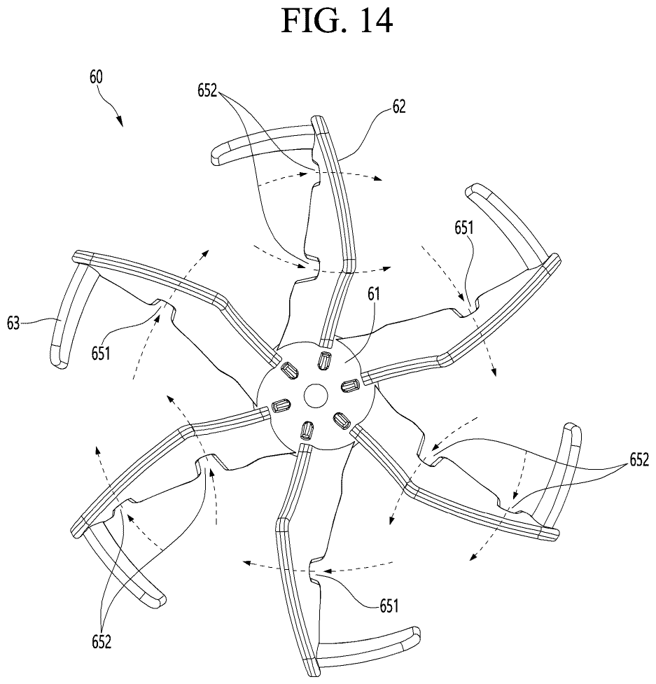

FIG. 11 is a perspective view of the mixing member, FIG. 12 is an enlarged view of the blade of the mixing member, FIG. 13 is a front view of the mixing member, and FIG. 14 is a plan view of the mixing member.

As illustrated, the mixing member 60 may be installed in the drawer 50 and may be drawn in and out together with the drawer 50. The mixing member 60 may be rotatably mounted within the first receiving portion 54. Rotation of the mixing member 60 allows the powdered detergent within the first receiving portion 54 to be mixed, and the powdered detergent may be more effectively dissolved in the supplied washing water.

The mixing member 60 may be formed in a fan shape with a plurality of blades 62. The mixing member 60 may also be referred to as a mixing fan or a rotating fan. For example, the mixing member 60 may include a rotating shaft 61 that serves as the center of rotation of the mixing member 60 and a plurality of blades 62 that extend radially from the rotating shaft 61.

Meanwhile, the rotating shaft 61 may be formed as a cylindrical shape with an open lower surface. Furthermore, the rotating shaft 61 may extend downward through the drawer 50.

In detail, the rotating shaft 61 may include an upper part 611 and a lower part 612. The upper part 611 is disposed inside the first receiving portion 54 and may protrude upward from the bottom of the first receiving portion 54. The upper part 611 may have a pointed top and a structure in which the diameter increases as it extends downward. Furthermore, a plurality of blades 62 may be formed on the circumferential surface of the upper part 611.

A rotational shaft groove 614 may be formed radially from the center of the rotational shaft 61 on the upper portion of the upper part 611. Due to the rotational shaft groove 614, the rotational shaft 61 and the blade 62 can be formed to precise dimensions without shrinkage during injection molding.

The lower part 612 may extend downward from the lower portion of the upper part 611 through the first receiving portion 54. The lower part 612 may further protrude downward through the lower surface of the drawer 50. Furthermore, the pinion 64 may be coupled to the lower portion of the lower part 612.

For example, a coupling groove 613 may be formed around the lower part 612 to which the pinion 64 is coupled. The pinion 64 may be coupled to the coupling groove 613 and rotate together with the mixing member 60.

The pinion 64 may be provided below the drawer 50 while coupled to the mixing member 60, and may be provided further below the lower surface of the housing 30 to be coupled to the rack 35.

The pinion 64 may rotate while moving along the rack 35, thereby rotating the mixing member 60. Accordingly, the rack 35 and pinion 64 can be referred a driving unit 70. And, the mixing member 60 can be rotated in conjunction with the withdrawal and entry of the drawer 50 by the driving unit 70.

The drive part 70 may also have various other structures that rotate the mixing member 60 in conjunction with the withdrawal or insertion of the drawer 50. For example, the drive part 70 may be configured as a motor and rotate the mixing member 60 when the drawer 50 is withdrawn or inserted. Alternatively, the drive part 70 may be configured as an elastic member and rotate the mixing member 60 by the elastic force provided when the drawer 50 is withdrawn or inserted.

The pinion 64 can rotate together with the mixing member 60 while being coupled. Furthermore, the pinion 64 can be drawn in and out simultaneously with the drawer 50 being withdrawn or inserted. Therefore, when the drawer 50 is drawn in and out, the pinion 64 rotates by being gear-coupled with the rack 35, thereby allowing the mixing member 60 to rotate.

Meanwhile, the blade 62 may include a front surface 621 corresponding to the direction of water sprayed from the first nozzle 451 for the rotation of the blade 62, and a rear surface 622 corresponding to the direction of water sprayed from the second nozzle 571 for the cleaning of the blade 62. Therefore, when water is sprayed from the first nozzle 451 while the drawer 50 is closed, the water can hit the front of the blade 62 to cause the blade 62 to rotate.

The blade 62 may include an upper end 621, a lower end 622, and left and right ends 623, 624.

The upper end 621 of the blade 62 may form an upper appearance of the blade 62. Furthermore, the upper end 621 of the blade 62 may extend from the rotating shaft 61 and may extend radially relative to the rotating shaft 61.

An upper groove 6211 may be formed at the upper end of the blade 62 adjacent to the rotating shaft 61. The upper groove may be recessed downward, and an end of the upper groove 6211 may be connected to the rotating shaft 61. The upper groove 6211 may reduce the vertical height of an end 623 of the blade 62. The adjacent position of the upper groove 6211 is not the point where the powdered detergent mixes with the water sprayed from the first nozzle 451. Therefore, the area of the blade 62 can be minimized, thereby reducing the weight of the mixing member 60.

Furthermore, the upper groove 6211 may be recessed downward, thereby preventing the powdered detergent from accumulating at the point where the upper end of the blade 62 and the rotating shaft 61 connect, and instead allowing the powdered detergent to flow down.

Among the upper end 621 of the blade 62, a position adjacent to the side end of the upper groove 6211 may protrude most upwardly. This position corresponds to approximately the central point in the extension direction of the blade 62, and may protrude upwardly so that the vertical height of the blade 62 becomes maximum. In addition, the upper end of the blade 62 becomes lower in height as it extends in the direction away from the rotating shaft 61. The upper end of the blade 62 may have a central portion protruding upward so that a striking area (A) where water sprayed from the first nozzle 451 collides may be located. Accordingly, the area of the striking area (A) may be expanded, and the rotational force of the mixing member 60 caused by the water sprayed from the first nozzle 451 may be increased.

The end 623 of the both ends of the blade 62 may be connected to the rotational shaft 61. The end 623 of the blade 62 may extend vertically and be connected at an angle relative to the rotating shaft 61. For example, the upper end of the end 623 of the blade 62 may move further in the rotational direction of the mixing member 60 than the lower end. Furthermore, the end 623 of the blade 62 may be formed to be inclined at a set angle (α) relative to a vertical line passing through the outer surface of the rotating shaft 61. In this case, the set angle (α) may be 15° to 30°. Accordingly, the extension line of the first nozzle 451 and the front surface 6201 of the blade 62 may intersect each other.

Among the two ends of the blade 62, the other end 624 that is farther away from the rotating shaft 61 can connect the upper end 621 and the lower end 622 of the blade 62. In addition, the other end 624 of the blade 62 can be positioned adjacent to the inner surface of the first receiving portion 54. In addition, an auxiliary blade 62 can be formed on the other end 624.

The auxiliary blade 62 may extend in a direction opposite to the rotational direction of the mixing member 60. The auxiliary blade 62 prevents powdered detergent from scattering due to water sprayed from the first nozzle 451. Furthermore, the auxiliary blade 62 prevents leaving the powdered detergent from moving outward along the blade 62 and facilitates mixing and dissolution of the powdered detergent with the washing water.

The lower end of the blade 62 may form the shape of the lower end of the blade 62. The lower end of the blade 62 may extend from the rotating shaft 61 and may extend radially relative to the rotating shaft 61. In this case, the lower end 622 may not be aligned vertically with the upper end 621 of the blade 62, and may extend in opposite directions, forming the blade 62 in an overall inclined or curved shape.

The striking area (A) may be formed between the upper and lower ends of the blade 62. The striking area (A) may be located above the blade groove 65, which will be described below. For example, the striking area (A) may be located above the center of the vertical height of the blade 62, and the blade groove 65 may be located below.

The lower end of the blade 62 may be positioned toward the bottom of the first receiving portion 54. The lower end 622 may be adjacent to the bottom of the first receiving portion 54, but spaced apart from it so as not to interfere with the rotation of the mixing member 60.

In addition, a lower recessed portion 6221 that is recessed upward and contacts the rotating shaft 61 may be formed at the lower end 6222. The lower recessed portion 6221 may be further spaced from the bottom of the first receiving portion 54. Therefore, powdered detergent may be prevented from clumping in the space between the lower end of the blade 62 adjacent to the rotating shaft 61, the rotating shaft 61, and the bottom of the first receiving portion 54, thereby impeding the rotation of the rotational shaft 61.

Meanwhile, the blade groove 65 may be formed on the blade 62. The blade groove 65 may be recessed upward from the lower end. The blade groove 65 may be cut from the lower end and extend upward. The blade groove 65 may be formed so that its width narrows as it extends upward from the lower end.

For example, the height (H2) of the blade groove 65 may extend from the lower end of the blade 62 to a point that is half the height (H1) from the lower end of the blade 62 to the upper end of the blade 62. If the height (H2) of the blade groove 65 is formed too high, the area at which the water sprayed from the first nozzle 451 is struck may become narrow, which may impede the rotation of the mixing member 60. In addition, the blade 62 may have a weak structural strength, which may reduce durability. In addition, if the height (H2) of the blade groove 65 is formed too low, the passage of powdered detergent through the blade groove 65 may not be smooth.

When the mixing member 60 rotates, some of the powdered detergent can pass through the blade grooves 65. Therefore, even when the amount of powdered detergent is large, the resistance exerted on the blades 62 during the rotation of the mixing member 60 can be reduced, facilitating smooth rotation of the mixing member 60. Furthermore, when the mixing member 60 rotates, the powdered detergent positioned between the blades 62 continuously passes through each of the blade grooves 65 formed on the plurality of blades 62. Therefore, the powdered detergent can be evenly distributed throughout the first receiving portion 54.

The blade grooves 65 may include a first blade groove 651 and a second blade groove 652. The first blade groove 651 may be formed as a single groove at the center of the blade 62. In addition, the second blade groove 652 is formed on a blade 62 adjacent to the blade 62 in which the first blade groove 651 is formed, and may be formed of two grooves on both sides spaced apart from the center of the blade 62.

That is, among the multiple blades 62, some may have a first blade groove 651 formed as a single groove, while neighboring blades 62 may have a second blade groove 652 formed as a pair of grooves.

At this time, the first blade groove 651 and the second blade groove 652 may be identical in size and shape. Of course, the second blade groove 652 may be formed smaller than the first blade groove 651. For example, the area of the first blade groove 651 plus the area of the pair of second blade grooves 652 may be equal.

Meanwhile, based on the rotational radius of the mixing member 60, the first blade groove 651 may be positioned between the pair of second blade grooves 652. Therefore, when the mixing member 60 rotates, the first blade groove 651 and the second blade groove 652 sequentially pass through a region of the first receiving portion 54, thereby continuously mixing the powdered detergent.

That is, the blade grooves 65 formed on each of the consecutive blades 62 may be formed at different locations. Furthermore, the blade grooves 65 formed on each of the adjacent blades 62 may be arranged so as not to overlap with each other based on the rotational radius of the blades 62, thereby allowing the powdered detergent within the first receiving portion 54 to move.

Hereinafter, the mixing operation of powder detergent according to the rotation of the mixing member 60 in the laundry machine 1 having the above structure will be described in detail with reference to the drawings.

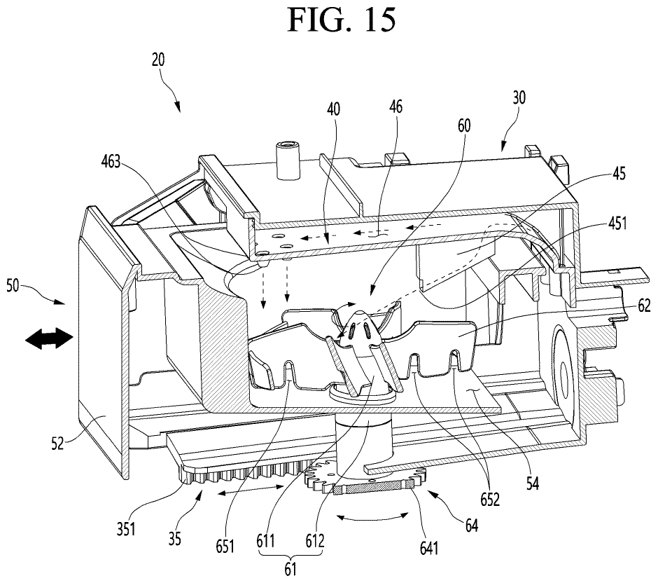

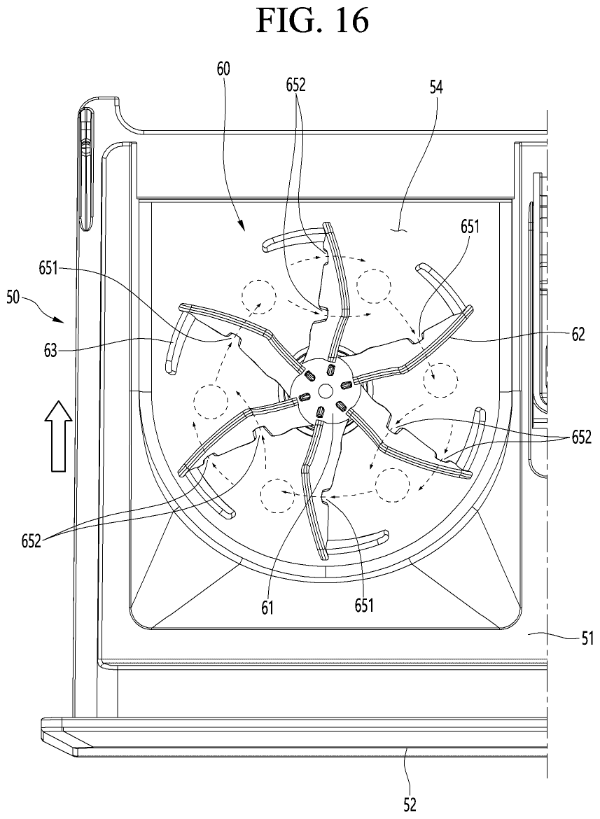

FIG. 15 is a cutaway perspective view showing the operating state of the mixing member, and FIG. 16 is a plan view showing the operating state of the mixing member.

As illustrated, the powdered detergent can be added to the detergent supply device 20 for the washing operation of the laundry machine 1. To add detergent to the receiving portion 53, the user can withdraw the drawer 50. When the user withdraws the drawer 50, the receiving portion 53 and the mixing member 60 can be exposed upward, as illustrated in FIG. 5.

In this state, the user can add powdered detergent to the first receiving portion 54. When adding powdered detergent, the user can add the powdered detergent to the first receiving portion 54 regardless of the internal condition of the first receiving portion 54 or the alignment of the mixing member 60.

Once the powder detergent is added to the first receiving portion 54, the user can insert the drawer. During the insertion process of the drawer 50, the rack 35 and the pinion 64 are gear-coupled with each other, and the pinion 64 can rotate while moving along the rack 35. Furthermore, the mixing member 60 can rotate due to the rotation of the pinion 64. Of course, the mixing member 60 can also rotate during the withdrawal process of the drawer 50 due to the gear engagement between the rack 35 and the pinion 64. Furthermore, if the rack 35 and the pinion 64 are omitted, the mixing member 60 may not rotate during the withdrawal process.

When the mixing member 60 rotates during the insertion process, the powder detergent introduced into the first receiving portion 54 can be mixed by the blade 62 and evenly distributed and redistributed within the first receiving portion 54. At this time, the powder detergent can be moved by passing through the blade grooves 65 of the mixing member 60. Therefore, even distribution of the powder detergent is possible, and the rotational motion of the mixing member 60 can be smoothly performed.

In detail, when the drawer 50 is inserted while the powdered detergent is locally disposed in the first receiving portion 54, the pinion 64 and the mixing member 60 can rotate due to the gear coupling between the rack 35 and the pinion 64. At this time, the rotational direction of the mixing member 60 may be identical to the rotational direction of the mixing member 60 caused by the water spray from the first nozzle 451.

During the rotation of the mixing member 60, the powdered detergent continuously passes through the first blade groove 651 and the second blade groove 652. That is, the rotation of the mixing member 60 causes the blade 62 to repeatedly pass through the interior of the first receiving portion 54. At this time, when the blade 62 in which the first blade groove 651 is formed passes, the powdered detergent moves through the first blade groove 651 in the center of the blade 62. Then, when the blade 62 in which the second blade groove 652 is formed passes, the powdered detergent moves through the second blade grooves 652 located on both sides based on the center of the blade 62.

In this way, the powdered detergent moves sequentially through the first blade groove 651 and the second blade groove 652. During this process, the powdered detergent within the first receiving portion 54 moves continuously through the blades 62 and is evenly distributed throughout the first receiving portion 54.

Meanwhile, when the drawer 50 is fully inserted, washing water is supplied from the water supply device 15 to the detergent supply device 20. The water supplied to the detergent supply device 20 can be supplied to the first receiving portion 54 through the flow path member 40.

In detail, the first nozzle 451 formed on the flow path member 40 sprays water onto the blade 62. The blade 62 collides with the water sprayed from the first nozzle 451, and the pressure of the water sprayed from the first nozzle 451 causes the mixing member 60 to rotate.

The powdered detergent supplied to the first receiving portion 54 can be mixed and dissolved with the wash water supplied to the first receiving portion 54 by the rotation of the mixing member 60. The dissolved powdered detergent and wash water fall downward through the opening at the rear of the first receiving portion 54 and are supplied to the tub 11 via the housing 30.

At this time, when the mixing member 60 rotates, the washing water and powdered detergent within the first receiving portion 54 sequentially pass through multiple blades 62. Specifically, the washing water and powdered detergent pass through the central portion of the blade 62 via the first blade groove 651 formed on one blade 62. Furthermore, they pass through the second blade groove 652 formed on the successive blades 62 to the two sides of the blade 62 away from the center.

Therefore, the washing water and powdered detergent, which have moved toward the center while passing through the blade 62, are dispersed and moved to the two sides while passing through another blade 62, and then again move toward the center while passing through another blade 62, and this process can be continuously repeated. That is, as the blade 62 rotates, the washing water and powdered detergent placed in the first receiving portion 54 can be moved while repeatedly passing through the center and both sides of the blades 62 to be mixed more effectively. Accordingly, the powdered detergent inside the first receiving portion 54 can be moved so as to be evenly distributed without being concentrated in any one area, and can be more effectively mixed and dissolved with the washing water.

What is claimed is:

1. A laundry machine, comprising:
a cabinet;
a tub rotatably disposed in the cabinet; and
a detergent supply device provided in the cabinet that mixes washing water and powdered detergent and discharges the mixture into the tub,
wherein the detergent supply device comprises:
a housing disposed at the cabinet;
a drawer that is withdrawably provided in the housing and has a receiving portion for receiving the powdered detergent; and
a mixing member disposed in the receiving portion that mixes the powdered detergent by rotation, and
wherein the mixing member includes a plurality of blades radially arranged around a rotating shaft, and
the blade is formed with a blade groove penetrating the blade to allow the powdered detergent to pass through the blade.

2. The laundry machine according to claim 1, wherein the blade groove is formed to extend upward from the bottom of the blade.

3. The laundry machine according to claim 2, wherein the blade groove becomes narrower as the blade groove extends upward.

4. The laundry machine according to claim 2, wherein the blade groove extends downwards further than a midpoint of the upper and lower heights of the blade.

5. The laundry machine according to claim 1, wherein the blade grooves are formed on each of the plurality of blades, and
the blade grooves formed on adjacent blades are formed at positions where they do not overlap each other during the rotation process.

6. The laundry machine according to claim 1, wherein the blade grooves are formed on each of the plurality of blades, and
the blade grooves formed on adjacent blades are formed in different numbers.

7. The laundry machine according to claim 6, wherein the sum of the areas of the blade grooves formed on each of the above blades is the same.

8. The laundry machine according to claim 1, wherein the blade groove comprises:
a first blade groove formed singly on a plurality of blades; and
a second blade groove formed in multiple numbers on a blade adjacent to the blade on which the first blade groove is formed.

9. The laundry machine according to claim 8, wherein the first blade groove is formed between the second blade grooves based on the rotation radius of the blade.

10. The laundry machine according to claim 8, wherein the first blade groove is formed in the center based on both ends of the blade.

11. The laundry machine according to claim 10, wherein the second blade grooves are provided on both sides based on the center of the blade.

12. The laundry machine according to claim 8, wherein the first blade groove and the second blade groove are formed to have the same size.

13. The laundry machine according to claim 1, wherein the housing is formed with a nozzle that sprays water toward the blade to rotate the mixing member, and
an opening of the nozzle is formed to face upwards of the blade groove.

14. The laundry machine according to claim 13, wherein the blade is formed so that an upper end of the blade is inclined more toward the direction of rotation of the mixing member than a lower end of the blade, and the extension line passing through the nozzle intersects the blade.

15. The laundry machine according to claim 13, wherein an upper surface of the housing is provided with a flow path member that forms a flow path for guiding the washing water, and
the flow path member is provided with a discharge path that is gradually inclined downward toward the blade, and the nozzle is formed at the end of the discharge path.

16. The laundry machine according to claim 1, wherein a lower surface of the housing is provided with a rack extending in the direction of withdrawal of the drawer, and
the mixing member is provided with a pinion connected to rotate with the drawer, and
the pinion is gear-coupled with the rack and rotates when the drawer is drawn in and out.

17. The laundry machine according to claim 16, wherein the rotating shaft extends downward through the bottom of the receiving portion, and
the pinion is coupled to the lower end of the rotating shaft at the lower end of the housing.

18. The laundry machine according to claim 17, wherein a housing recess is formed on the lower front end of the housing to prevent interference of the pinion when the drawer is drawn in and out.

19. The laundry machine according to claim 1, wherein the blade groove is opened toward the bottom of the receiving portion, and
a lower end of the blade groove is spaced apart from the bottom of the receiving portion.

20. The laundry machine according to claim 1, wherein an auxiliary blade extending in the opposite direction to the rotational direction of the mixing member is formed at one end of the blade farthest from the rotating shaft.
